(19) United States
(12) Patent Application Publication
(10) Pub. No.: US 2017/0140497 A1
(43) Pub. Date: May 18, 2017

(54) DISPLAY OPERATION SYSTEM

(71) Applicant: Mitsubishi Electric Corporation, Tokyo (JP)

(72) Inventor: Kengo KOARA, Tokyo (JP)

(73) Assignee: Mitsubishi Electric Corporation, Tokyo (JP)

(21) Appl. No.: 15/318,520

(22) PCT Filed: Jul. 29, 2014
(86) PCT No.: PCT/JP2014/069968

§ 371 Date: Dec. 13, 2016

(51) Int. Cl. G06T 1/20; G06F 3/14; G06T 1/60; G06F 17/30; G06F 3/06

(52) U.S. Cl. CPC G06T 1/20; G06F 17/30864; G06F 3/065; G06F 3/0619; G06F 3/067; G06T 1/60; G06F 3/1423

(57) ABSTRACT

A display operation system enabling consolidated control over the entire system and individual and independent control over each display operation terminal apparatus; a server apparatus operates according to server-use drawing data defining a function of the server apparatus, client apparatuses operate by acquiring, from the server apparatus through a connection path, client-use drawing data defining functions of the client apparatuses in common and by interpreting it, the server apparatus and the client apparatuses include internal device memories allowing values to be read therefrom and written thereto, the internal device memories include client specific device areas storing information necessary for independent control of the server apparatus or the client apparatuses and all-client common device areas storing information necessary for control common to the server apparatus and the client apparatuses.

### FIELD

The present invention relates to a display operation system that enables a user to freely design drawing data that defines a screen and a function.

### BACKGROUND

Conventionally production equipment and machining equipment in a common type of plant include a programmable logic controller (PLC) for controlling the operation of an apparatus, a motion controller for driving an actuator, a servo amplifier, a control apparatus, a temperature regulator for managing temperature, and various types of sensors for sensing the states of apparatuses. The actuator can be exemplified by a motor. The control apparatus can be exemplified by an inverter. Such production equipment and machining equipment have included an indicator control panel that includes meters, lamps, and switches for monitoring the operation state and operating the equipment. In recent years, in place of such indicator control panels, programmable displays, which have a communication function of allowing a display section of a touch panel or a liquid crystal panel to communicate with an external connection apparatus (for example, a PLC) and read from and write to the device memory of the external connection apparatus and allow the screens and functions to be designed and changed freely, are entering widespread use. With the use of such a programmable display, a display operation system that is more flexible and space-saving than that using the conventional indicator control panel can be configured. The function of a programmable display is designed by using application software referred to as drawing software. Data designed and created by using the drawing software is called drawing data. The drawing software allows a component like a switch or a lamp, referred to as an object, to be placed in a screen and allows an operator to designate a device memory represented and operated by such an object and assign an action thereto to thereby design a function of a programmable display; thus, the operator is required to have no programming knowledge. Furthermore, an apparatus that enables a programmable display to be connected to a terminal apparatus via a network such that a screen of the programmable display can be viewed and operated from the terminal apparatus has been commercialized.

For example, in Patent Literature 1, for the purpose of “permitting a client apparatus to operate a desired application program without affecting the application program an image of which is displayed on a server apparatus, by restricting the operation of the application program from the client apparatus,” a technique is disclosed; that is, with the technique, “on receipt of a request from a client computer 2, a server computer 1 reads a designated rectangular area in image data of an application program from a client-use loading area 131 on the basis of an application designating number and rectangular range data set in a setting file SF1 and transmits the rectangular area to the client computer 2. The client computer 2 is allowed to operate the application program within the range of the rectangular area. The client-use loading area 131, in which the image data for the client computer 2 is loaded, is independent of a server-use loading area 121 in which image data to be displayed on a display device 14 is loaded”. In Patent Literature 1, an application installed in a terminal apparatus acquires, as image information, what is displayed on a programmable display connected via a network, displays it, and transfers operation coordinates on the application at the terminal apparatus to the programmable display to thereby allow the remote terminal apparatus to view and operate the screen of the programmable display. In Patent Literature 1, by “including an image data storage unit including a plurality of storage areas that store at least a part of image data of an application program in a server apparatus, and causing the reading unit to read image data individually from each of the storage areas in the image data storage unit in accordance with a request from each client apparatus,” an image independent of that of the server apparatus can be displayed for each client apparatus. Additionally, the server apparatus, which is connected to an external connection apparatus such as a PLC, controls an apparatus by reading from and writing to the external device memory; the server apparatus entirely performs processing on information displayed on a client apparatus and the result of operation by the client apparatus, so that the client apparatus and the external connection apparatus do not communicate with each other directly. Thus, it is only the server apparatus that should be capable of processing various types of settings for connection, such as a communication protocol of an external connection apparatus and an IP address for identifying a connection target.

### CITATION LIST

### Patent Literature

Patent Literature 1: Japanese Patent Application Laid-Open No. 2010-256972

### SUMMARY

### Technical Problem

In the conventional technique described above, each client apparatus is only allowed to display a screen generated by the server apparatus; therefore, it is required that the server apparatus has sufficient memory available to store a screen and devices for each client apparatus in order to provide a notification device and a control device unique to each client apparatus and that the server apparatus control everything. Thus, the conventional technique is problematic in that achievement of the technique is difficult for a built-in apparatus, which in general has restriction on the sizes of a CPU and memory, such as a programmable display, for example. Additionally, in the case where the server apparatus and the client apparatuses are used simultaneously in the conventional technique described above, permitting the display operation terminal apparatuses to simultaneously perform operations to change the device memory of the external connection apparatus may allow an operator of another display operation terminal apparatus to perform an operation. Hence, the conventional technique has a problem in that it may allow an unauthorized operation to be performed on a system being controlled.

The present invention has been achieved in view of the above, and an object of the present invention is to provide a display operation system that enables a server apparatus to exercise consolidated control over the entire system and each display operation terminal apparatus to perform independent control individually.

### Solution to Problem

In order to solve the above problems and achieve the object, an aspect of the present invention is a display operation system in which a server apparatus is connected to a client apparatus and an operation is performed with a monitor screen of the client apparatus. The server apparatus and the client apparatus each include a device memory to allow a value to be read from and written to the device memory, and individual and independent control in the server apparatus or the client apparatus including the device memory and consolidated control over the display operation system by the server apparatus are enabled with data stored in the device memory.

### Advantageous Effects of Invention

A display operation system according to the present invention produces an effect of being capable of producing a display operation system that enables a server apparatus to exercise consolidated control over the entire system and each display operation terminal apparatus to perform independent control individually.

### BRIEF DESCRIPTION OF DRAWINGS

FIG. 1 is a block diagram illustrating an overall configuration of a server-client type display operation system according to an embodiment.

FIG. 2 is a block diagram illustrating the configuration of a server apparatus control unit.

FIG. 3 is a block diagram illustrating the configuration of a client apparatus control unit.

FIG. 4 is a diagram illustrating address spaces in internal device memories.

FIG. 5 is a flowchart illustrating processing performed when a client apparatus is connected to a server apparatus.

FIG. 6 is a flowchart illustrating processing performed when the client apparatus generates a writing request to a device memory.

FIG. 7 is a flowchart illustrating device writing processing performed from a display operation terminal apparatus according to a result of operator authentication.

FIG. 8 is a state transition diagram illustrating the state of an operation right, for describing exclusive control of the operation right.

FIG. 9 is a flowchart illustrating writing processing in accordance with the operation right.

### DESCRIPTION OF EMBODIMENT

An exemplary embodiment of a display operation system according to the present invention will now be described in detail with reference to the drawings. The present invention is not limited to the embodiment.

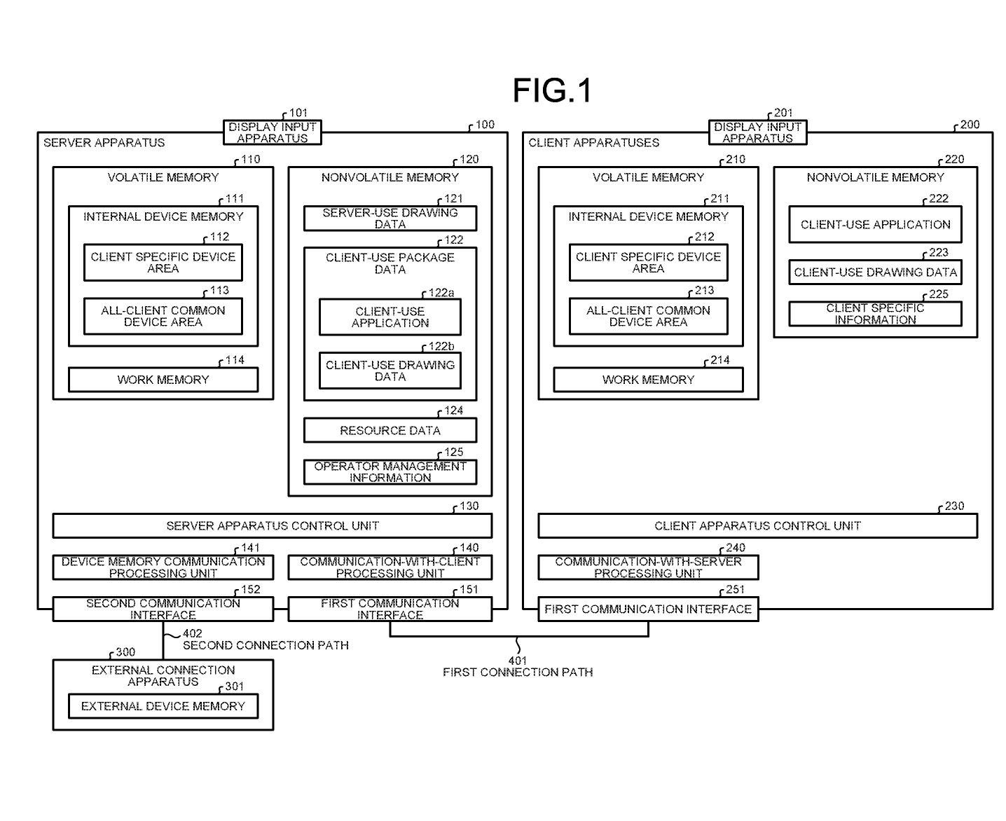

FIG. 1 is a block diagram illustrating an overall configuration of a server-client type display operation system according to the present invention. As illustrated in FIG. 1, one server apparatus 100 is connected to a plurality of client apparatuses 200 through a first connection path 401. The server apparatus 100 is also connected to an external connection apparatus 300 (a programmable logic controller (PLC), for example) through a second connection path 402.

The communication specification for the first connection path 401 is preferably Ethernet (registered trademark). However, the communication specification for the first connection path 401 is not limited to Ethernet (registered trademark); it may be other communication specifications that enable the server apparatus 100 to be connected to the client apparatuses 200.

The communication specification for the second connection path 402 is also, for example, Ethernet (registered trademark). Alternatively, the second connection path 402 may be serial communication or a field network. The serial communication can be exemplified by RS232. The field network can be exemplified by CC-Link (registered trademark). The communication specification for the second connection path 402 is not limited to Ethernet (registered trademark), RS232, or CC-Link (registered trademark); it may be other communication specifications that enable the server apparatus 100 to be connected to the external connection apparatus 300. The display operation system according to the present invention may exclude the second connection path 402 and the external connection apparatus 300.

The server apparatus 100 illustrated in FIG. 1 includes a display input apparatus 101, a volatile memory 110, a nonvolatile memory 120, a server apparatus control unit 130, a communication-with-client processing unit 140, a device memory communication processing unit 141, a first communication interface 151, and a second communication interface 152.

The display input apparatus 101 is, for example, a touch panel that combines a display apparatus and a position input apparatus. Here, the display apparatus may be, for example, a liquid crystal display (LCD). The position input apparatus is an input device that can detect a position operated by a user or a position pressed by a user.

The volatile memory 110 includes an internal device memory 111 and a work memory 114. The volatile memory 110 is, for example, SDRAM (Synchronous Dynamic Random Access Memory). The nonvolatile memory 120 includes server-use drawing data 121, client-use package data 122, resource data 124, and operator management information 125. The nonvolatile memory 120 is, for example, a flash ROM built in the server apparatus 100 or an external storage medium removable from the server apparatus 100, which is, for example, an SD memory card (registered trademark).

The first communication interface 151 is an interface that connects the server apparatus 100 to the first connection path 401. The second communication interface 152 is an interface that connects the server apparatus 100 to the second connection path 402. Information on the communication through the first communication interface 151 is processed by the communication-with-client processing unit 140. Information on the communication through the second communication interface 152 is processed by the device memory communication processing unit 141.

An action of the server apparatus 100 is defined by the server-use drawing data 121 stored in the nonvolatile memory 120. The server apparatus control unit 130 interprets the server-use drawing data 121, performs display processing on a screen of the server apparatus 100 and an object to be placed in the screen of the server apparatus 100, and processes information input from the display input apparatus 101. An object to be placed in the screen of the server apparatus 100 is a display component that receives information display and operation input. The server apparatus control unit 130 also reads from and writes to an external device memory 301 in the external connection apparatus 300 and the internal device memory 111 in the volatile memory 110 through the device memory communication processing unit 141 in accordance with the server-use drawing data 121.

The work memory 114 retains computation of data performed by the server apparatus control unit 130 or data being processed, or stores screen information to be displayed on the display input apparatus 101. The work memory 114 is made available independently of the internal device memory 111.

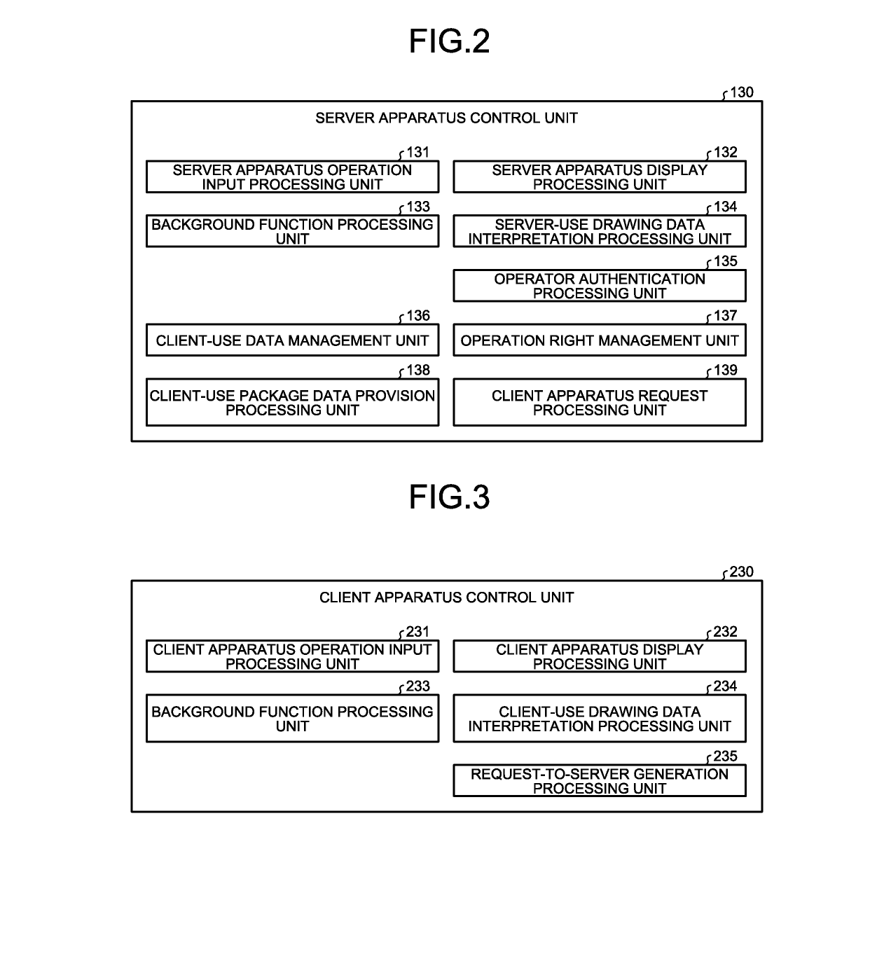

FIG. 2 is a block diagram illustrating the configuration of the server apparatus control unit 130. The server apparatus control unit 130 includes a server apparatus operation input processing unit 131, a server apparatus display processing unit 132, a background function processing unit 133, a server-use drawing data interpretation processing unit 134, an operator authentication processing unit 135, a client-use data management unit 136, an operation right management unit 137, a client-use package data provision processing unit 138, and a client apparatus request processing unit 139.

The server-use drawing data interpretation processing unit 134 reads the server-use drawing data 121 sequentially and interprets it. The server apparatus control unit 130 provides instructions to the server apparatus operation input processing unit 131, the server apparatus display processing unit 132, and the background function processing unit 133 as per the interpretation of the server-use drawing data 121, and the server apparatus operation input processing unit 131, the server apparatus display processing unit 132, and the background function processing unit 133 respond to the instructions. The server apparatus control unit 130 achieves various functions in accordance with the server-use drawing data 121 by determining a next action as per the responses.

The server apparatus operation input processing unit 131 processes an operation input. The server apparatus display processing unit 132 performs display processing on an object. The background function processing unit 133 performs processing of, for example, a logging function, an alarm monitoring function, and a script function. The logging function is a function of regularly monitoring and recording values of the external device memory 301 and the internal device memory 111. The alarm monitoring function is a function of monitoring a change in value and recording time-series information with an alarm indicating that a predetermined condition has been satisfied. The script function is a function of executing an interpreter-type program, which is also called a script, to reference and update the external device memory 301 and the internal device memory 111. The background function processing unit 133 accumulates the resource data 124, which is collected data, in the nonvolatile memory 120. When accumulated information is to be displayed as an object, the background function processing unit 133 also reads the resource data 124 from the nonvolatile memory 120 and extracts and processes information necessary for displaying.

The client apparatus request processing unit 139 makes an assessment of various requests from the client apparatuses 200 and processes them. When a request from the client apparatus 200 is to provide the client-use package data 122, the client-use package data provision processing unit 138 extracts a part or all of a client-use application 122a and client-use drawing data 122b contained in the client-use package data 122.

The client-use data management unit 136 manages the state of connection with the client apparatuses 200 when the client apparatuses 200 are connected to the server apparatus 100.

The operator authentication processing unit 135 authenticates an operator who is to operate the server apparatus 100 or the client apparatus 200 on the basis of the operator's user information, which is, for example, a combination of a user name and a password, and controls the authority of the operator in accordance with the result of the authentication.

When exclusive control of an operation right is to be performed, the operation right management unit 137 grants the operation right to the server apparatus 100 or the client apparatus 200 and manages the content of the authority. The content of the authority managed by the operation right management unit 137 will be described hereinafter.

Each of the client apparatuses 200 illustrated in FIG. 1 includes a display input apparatus 201, a volatile memory 210, a nonvolatile memory 220, a client apparatus control unit 230, a communication-with-server processing unit 240, and a first communication interface 251.

Like the display input apparatus 101 of the server apparatus 100, the display input apparatus 201 is, for example, a touch panel that combines a display apparatus and a position input apparatus. Like the volatile memory 110, the volatile memory 210 includes an internal device memory 211 and a work memory 214 and is, for example, SDRAM. The nonvolatile memory 220 includes a client-use application 222, client-use drawing data 223, and client specific information 225 and is, for example, a flash ROM built in the client apparatus 200 or an external storage medium removable from the client apparatus 200, which is, for example, an SD memory card (registered trademark).

The first communication interface 251 is an interface that connects the client apparatus 200 to the first connection path 401. Information on the communication through the first communication interface 251 is processed by the communication-with-server processing unit 240.

An action of the client apparatus 200 is defined by the client-use drawing data 223 stored in the nonvolatile memory 220. Here, the client-use drawing data 223 is a part or all of the client-use drawing data 122b stored in the nonvolatile memory 120 of the server apparatus 100 through the first communication interface 251 and acquired when connection with the server apparatus 100 is made or when a screen displayed on the client apparatus 200 is switched. The client apparatus control unit 230 interprets the client-use drawing data 223, performs display processing on the screen of the client apparatus 200 and an object to be placed in the screen, and processes information input from the display input apparatus 201. An object to be placed in the screen of the client apparatus 200 is a display component that receives information display and operation input. When it is necessary to read from or write to a device memory, the client apparatus control unit 230 issues a request of device reading/writing to the server apparatus 100 through the communication-with-server processing unit 240.

The work memory 214 retains computation of data performed by the client apparatus control unit 230 or data being processed, or stores screen information to be displayed on the display input apparatus 201. The work memory 214 is made available independently of the internal device memory 211.

The client specific information 225 is information for identifying each of the client apparatuses 200. The client specific information 225 can be exemplified by an IP address in Ethernet (registered trademark) or a user identifier like a user name or a user ID.

Each of the client apparatuses 200 may acquire the client-use application 222 from the server apparatus 100. That is, the client-use application 222 may be the client-use application 122a.

FIG. 3 is a block diagram illustrating the configuration of the client apparatus control unit 230. The client apparatus control unit 230 includes a client apparatus operation input processing unit 231, a client apparatus display processing unit 232, a background function processing unit 233, a client-use drawing data interpretation processing unit 234, and a request-to-server generation processing unit 235.

The client-use drawing data interpretation processing unit 234 reads the client-use drawing data 223 sequentially and interprets it. The client apparatus control unit 230 provides instructions to the client apparatus operation input processing unit 231, the client apparatus display processing unit 232, and the background function processing unit 233 as per the interpretation of the client-use drawing data 223, and the client apparatus operation input processing unit 231, the client apparatus display processing unit 232, and the background function processing unit 233 respond to the instructions. The client apparatus control unit 230 achieves various functions in accordance with the client-use drawing data 223 by determining a next action as per the responses.

The client apparatus operation input processing unit 231 processes an operation input. The client apparatus display processing unit 232 performs display processing on an object. The background function processing unit 233 performs processing of, for example, a logging function, an alarm monitoring function, and a script function. The request-to-server generation processing unit 235 generates a request to the server apparatus 100. The request is, for example, a request to acquire data from the server apparatus 100 or the external connection apparatus 300. The client apparatuses 200 are not permanently connected to the server apparatus 100. Thus, it is preferable that, of the background functions processed by the background function processing unit 233, functions of collecting time-series information in particular be processed by the server apparatus 100 centrally and that each of the client apparatuses 200 be, then, enabled to acquire a result of the processing by the server apparatus 100, rather than allowing each of the client apparatuses 200 to process these functions in a distributed manner. Of the background functions, the functions of collecting time-series information are, for example, the logging function and the alarm monitoring function.

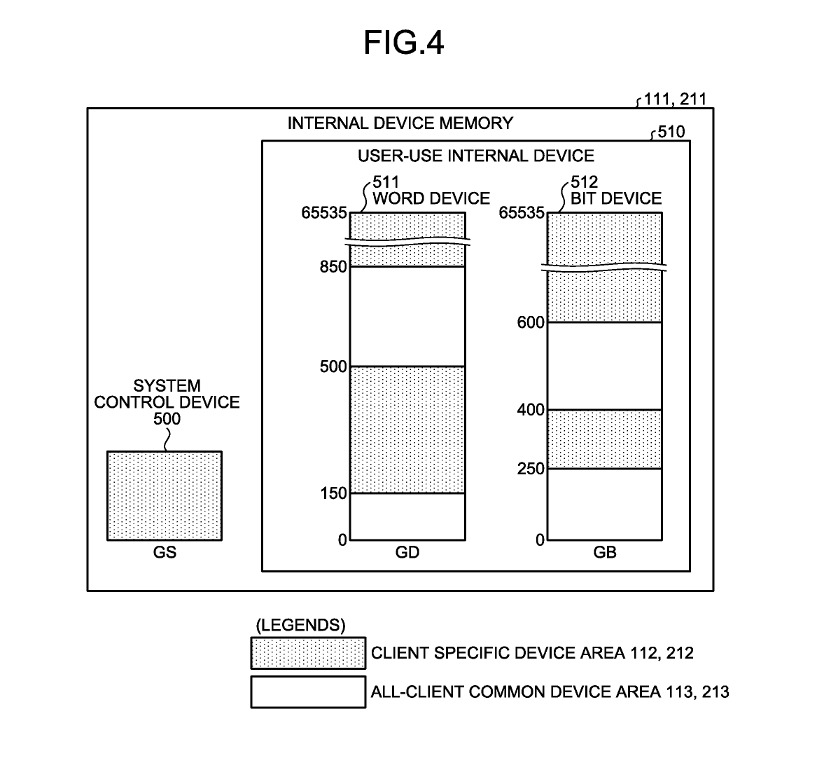

FIG. 4 is a diagram illustrating an address spaces in the internal device memory 111 of the server apparatus 100 and the internal device memory 211 of each of the client apparatuses 200. The internal device memory 111 is physically located in the server apparatus 100. The internal device memory 211 is physically located in each of the client apparatuses 200. The size of the address space in the internal device memory 111 is the same with the size of the address space in the internal device memory 211.

In the address space of the internal device memory 111, distinction is made between an all-client common device area 113 and a client specific device area 112. In the address space of the internal device memory 211, distinction is made between an all-client common device area 213 and a client specific device area 212. Values in the all-client common device areas 113 and 213 are shared and synchronized between the server apparatus 100 and all of the client apparatuses 200. The client specific device areas 112 and 212 of the server apparatus 100 and each of the client apparatuses 200 have independent values.

The locations of the client specific device areas 112 and 212 and the all-client common device areas 113 and 213 are allocated by the server-use drawing data 121 and the client-use drawing data 122b and 223. The allocation of the areas is common to the server-use drawing data 121 and the client-use drawing data 122b and 223.

Values in the all-client common device areas 113 and 213 are managed by the server apparatus 100, and values in the all-client common device area 213 are synchronized with the server apparatus 100 regularly through the first connection path 401. The client specific device areas 112 and 212 are managed by the server apparatus 100 and each of the client apparatuses 200 independently and not to be accessed by any apparatus other than the apparatus in which a corresponding one of the client specific device areas 112 and 212 is included.

Here, the server apparatus 100 also includes the client specific device area 112 and the all-client common device area 113. This is because the client specific device area 112 and the all-client common device area 113 are areas accessed only by the server apparatus 100. The client specific device area may be called a specific device area, an apparatus-specific device area, or an apparatus' own specific device area. The all-client common device area may be called a common device area or an all-apparatus common device area.

More specifically, as illustrated in FIG. 4, a user-use internal device 510, which can be used by a designer freely, and a system control device 500, which is reserved for control and state notification of a corresponding display operation terminal apparatus, are included in the internal device memory 111. Here, the display operation terminal apparatus is a generic name for the server apparatus 100 and the client apparatuses 200.

The user-use internal device 510 includes a word device 511, which stores word data, and a bit device 512, which stores bitwise data. The word data is, for example, a numerical value. A symbol is assigned to each of the system control device 500, the word device 511, and the bit device 512 to distinguish areas; for example, the symbol for the system control device 500 is GS, the symbol for the word device 511 in the user-use internal device 510 is GD, and the symbol for the bit device 512 in the user-use internal device 510 is GB. An address within the internal device memories 111 and 211 is assigned to each area by using, for example, an index of a serial number starting with zero. For example, the 101st element in the word device 511 is “GD100”. The system control device 500 is allocated fixedly and serves as the client specific device area 112 or 212. In the word device 511 and the bit device 512 of the user-use internal device 510, the all-client common device areas 113 and 213 are defined by the server-use drawing data 121 and the client-use drawing data 122b and 223, and the remaining areas are defined as the client specific device areas 112 and 212. In FIG. 4, addresses GD0 to GD149, GD500 to GD849, GB0 to GB249, and GB400 to GB599 are of the all-client common device areas 113 and 213, and the remaining areas are of the client specific device areas 112 and 212.

An area in the external device memory 301 is also expressed with a symbol and an index. Although different models have different expressions in PLC, in one type of PLC, for example, space types of a word device are expressed with symbols D and R and indexes, and space types of a bit device are expressed with symbols M, X, and Y and indexes.

The configuration of the display operation system including the server apparatus and the client apparatuses has been described above, although the present invention is not limited to the configuration described above. In the foregoing description, the server apparatus 100 includes the display input apparatus 101 and each of the client apparatuses 200 includes the display input apparatus 201, although a display apparatus and an input apparatus may be provided separately. Here, the display apparatus can be exemplified by an LCD, and the input apparatus can be exemplified by a mouse and a keyboard.

Furthermore, it is possible for the server apparatus 100 not to include the display input apparatus 101, and the server apparatus 100 may be configured to process only the background functions.

In the server-client type display operation system having the configuration described above, each of the client apparatuses 200 performs a connection operation to connect to the server apparatus 100 at any given point in time during the operation of the server apparatus 100. The connection operation described here is an operation to specify the server apparatus 100, which is to be connected, by selecting the server apparatus 100 from a list in a menu screen displayed on each of the client apparatuses 200 or by directly inputting the IP address or the host name of the server apparatus 100.

In the case where the server apparatus 100 is, for example, a Web server that processes the general HTTP (Hyper Text Transfer Protocol) in the WWW (World Wide Web), the client apparatuses 200 may be tablet PCs or personal computers loaded with Web browser software. In the case where the client apparatuses 200 are tablet PCs or personal computers loaded with Web browser software, the connection operation may be an operation to select the server apparatus 100 from bookmarks of the Web browser software.

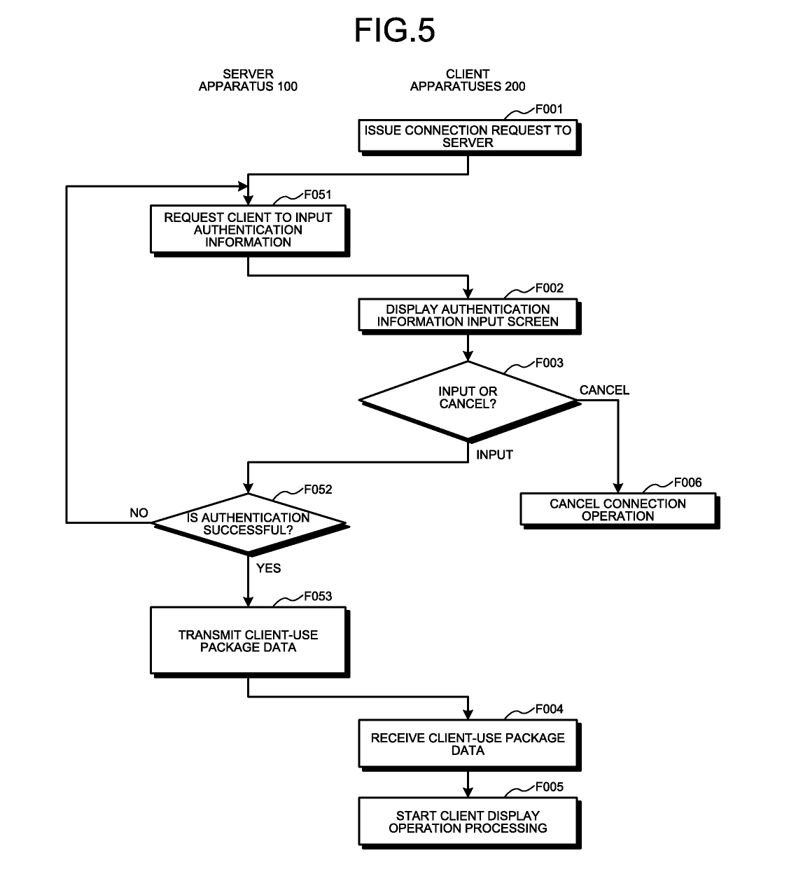

FIG. 5 is a flowchart illustrating processing performed when the client apparatus 200 is connected to the server apparatus 100. First, the client apparatus 200 issues a connection request to the server apparatus 100 (F001). Upon receipt of the connection request by the communication-with-client processing unit 140, the server apparatus 100 requests the client apparatus 200 to input authentication information (F051). Upon receipt of the request to input authentication information, the client apparatus 200 displays an authentication information input screen (F002).

The authentication information can be exemplified by, for example, a combination of a user ID and a password. The authentication information input screen can be exemplified by, for example, a dialog screen, although the authentication information input screen is not limited to a dialog screen. Alternatively, without the use of a special authentication screen, authentication information preregistered in the client apparatus 200 may be used, or authentication information may be automatically input when a user connects a USB dongle having stored the authentication information to the client apparatus 200. In the case where the authentication information input screen is displayed (F002) on the client apparatus 200 for manual input, the screen is preferably configured to allow the operation to be cancelled. In the case where the authentication is performed with the automatic input, if the authentication fails, the client apparatus 200 may provide a notification of the failure of the authentication and display a screen to prompt for reviewing the registered key.

Then, the client apparatus 200 determines whether the authentication information is input or connection is cancelled (F003). If the authentication information is cancelled, that is, if, in F003, the flowchart takes the path of “cancelled”, the connection operation is cancelled (F006) such that no connection to the server apparatus 100 is performed.

If the authentication information is input, that is, if, in F003, the flowchart takes the path of “input”, determination whether or not the authentication is successful is made (F052). If the authentication fails, that is, if, in F052, the flowchart takes the path of No, the client apparatus 200 is requested again to input the authentication information (F051). If the authentication is successful, that is, if, in F052, the flowchart takes the path of Yes, the server apparatus 100 transmits all or a part of the client-use package data 122 to the client apparatus 200 (F053).

Here, whether all or a part of the client-use package data 122 is to be transmitted is determined on the basis of a setting of the system. If all of the client-use package data 122 is to be transmitted, the amount of communication data to be transmitted when the client apparatus 200 is connected to the server apparatus 100 increases, and thus a period of time from the start of connection to the completion of the connection increases. If a part of the client-use package data 122 is to be transmitted, the communication time can be reduced in comparison with the case where all of the client-use package data 122 is to be transmitted, by transmitting a portion that needs to be processed regardless of a screen to be displayed, a part of the client-use drawing data 122b including a part of a screen displayed initially, and the client-use application 122a for enabling the client apparatus 200 to operate.

Furthermore, when the client-use package data 122 read in the past is cached by the client apparatus 200, that is, when it is temporarily stored in the volatile memory 210 or the nonvolatile memory 220, such that the cached information is not re-transmitted by the server apparatus 100, the communication time can be further reduced. Allowing the client apparatus 200 to cache the client-use package data 122 that is read in the past is not preferable in some cases from the viewpoint of security and protection of the asset; thus, it is preferable that whether or not caching is enabled can be selected depending on the target system. Alternatively, the client-use application 122a may be preinstalled in the client apparatus 200. In the case where the client-use application 122a is preinstalled in the client apparatus 200, the client apparatus 200 may receive only the client-use drawing data 122b from the server apparatus 100 when connected; thus, the communication time can be reduced.

When the client apparatus 200 receives the client-use package data 122 transmitted from the server apparatus 100 to the client apparatus 200 as described above (F004), the client apparatus 200 starts display operation processing of the client apparatus 200 by enabling the client-use drawing data interpretation processing unit 234 to interpret the client-use application 122a (F005).

When the client apparatus 200 is connected to the server apparatus 100 as described above, the server apparatus 100 registers the client specific information 225 that identifies the newly connected client apparatus 200 in the client-use data management unit 136 of the server apparatus control unit 130. When the connection of the client apparatus 200 with the server apparatus 100 is released, the information on the client apparatus 200 the connection of which is released is deleted from the client specific information 225. In this manner, the client specific information 225 on all the connected client apparatuses 200 is registered in the client-use data management unit 136, such that the server apparatus 100 can identify and know the currently connected client apparatuses 200.

Furthermore, a clandestine access by an unauthenticated client apparatus 200 to the server apparatus 100 can be prevented by including the client specific information 225 and a hash value in a packet in communication between the server apparatus 100 and the client apparatus 200. A hash value is generated from, for example, time information.

During connection between the client apparatus 200 and the server apparatus 100, the client apparatus 200 reads periodically a screen currently displayed on the client apparatus 200 or a value of each device memory regularly referenced by a function operating in the background. For the external device memory 301 and the all-client common device areas 113 and 213, the client apparatus 200 regularly issues a device-value reading request to the server apparatus 100.

The server apparatus 100 interprets a device-value reading request from the client apparatus 200 and, if the address of the external device memory 301 contained in the device-value reading request is not of a device memory of the monitoring target from which the server apparatus 100 is reading regularly, registers the address of the external device memory 301 as a new monitoring target, such that the server apparatus 100 reads from the external device memory 301 out of synchronization with the request from the client apparatus 200 and retains the result of reading in the work memory 114 of the server apparatus 100. The server apparatus 100 reads the device value retained in the work memory 114 and notifies the client apparatus 200. The method described above is referred to as a “registered-device reading method”.

For the client specific device area 212, the client apparatus 200 performs appropriate exclusive control internally and then performs reading and writing at any given point in time without inquiring of the server apparatus 100.

Each of the display operation terminal apparatuses also has a function of initiating an action to read from and write to various device memories only when an object, such as a touch switch, is operated or when a trigger condition is satisfied. To enable the client apparatus 200 to execute such a function, the client apparatus 200 issues a device reading request and a device writing request to the server apparatus 100 every time an action is initiated. The server apparatus 100 interprets the content of the requests and, if the target of reading/writing is the external device memory 301, performs device reading/writing processing that corresponds to the requests through the device memory communication processing unit 141, stores the result of the processing in the work memory 114 temporarily, and notifies the client apparatus 200 of the result of device reading/writing at a timing when the server apparatus 100 returns a response to the client apparatus 200. The method in which the server apparatus 100 performs device reading/writing every time a device reading/writing request is received from the client apparatus 200 as described above is referred to as a “sequential device reading method” and a “sequential device writing method”.

In the case where the external device memory 301 is to be read, the registered-device reading method described above may not be capable of acquiring the latest value at the timing of a communication request by the client apparatus 200. However, when one or more of the client apparatuses 200 is/are connected to the server apparatus 100 simultaneously and an identical device memory is referenced simultaneously, integrating common device memory can suppress the amount of communication between the external connection apparatus 300 and the server apparatus 100 and reduce a burden on the external connection apparatus 300 and the second connection path 402.

The sequential device reading method involves a longer period of time from a request to a response than the registered-device reading method because, in the sequential device reading method, after the client apparatus 200 issues a request to the server apparatus 100, the server apparatus 100 communicates with the external connection apparatus 300, receives a response, and then responds to the client apparatus 200. However, since a device value generated after the generation of a request can be obtained reliably in this way, the sequential device reading method may be preferable when synchronous processing is required in cases such as when sequential processing is performed on the basis of a device value.

Furthermore, the registered-device reading method is problematic in that, since communication with the external connection apparatus 300 is performed periodically even when a registered device value is not being used, the time taken to process communication for the entire system may be prolonged. Thus, when the timing at which communication occurs is sporadic, use of the sequential device reading method may be preferable, and a combination of these methods is preferably determined automatically as per a setting of the drawing data. Note that the present invention is not limited to such methods and may be configured to specify a method explicitly at the creation stage of drawing data.

The communication between the server apparatus 100 and the client apparatus 200 is performed by a dedicated communication protocol that can be understood by the communication-with-client processing unit 140 and the communication-with-server processing unit 240. A communication protocol for the communication between the server apparatus 100 and the external connection apparatus 300 is in general determined by the external connection apparatus 300, and, thus, the server apparatus 100 performs the communication by a communication protocol that conforms to the connected external connection apparatus 300. Hence, when using the registered-device reading method, the sequential device reading method, or the sequential device writing method, there is no need for the client apparatus 200 to process a communication protocol for communication with the external connection apparatus 300.

Here, there is no need for an action like that of a so-called protocol converter to perform sequential conversion between the communication protocol for the server apparatus 100 and the client apparatus 200 and the communication protocol for the server apparatus 100 and the external connection apparatus 300. When the server apparatus 100 receives a request from the client apparatus 200, the server apparatus 100 may process the request at a timing when the server apparatus 100 can process it and then communicate with the external connection apparatus 300.

Although not depicted in FIG. 1, when the client apparatus 200 is to read from and write to the external device memory 301 of the external connection apparatus 300, a case where the first connection path 401 is identical with the second connection path 402 is assumed, or a case where the server apparatus 100 allows a communication request received from the client apparatus 200 through the first connection path 401 to pass through the second connection path 402 without processing the request is assumed. To provide for such cases, each of the client apparatuses 200 may have a function of generating the communication protocol of the external connection apparatus 300, that is, a function that corresponds to the device memory communication processing unit 141 of the server apparatus 100.

While the foregoing description focuses on reading from and writing to the external device memory 301, to read from and write to the all-client common device area 113, the server apparatus 100, upon receipt of a request from the client apparatus 200, performs suitable exclusive control on the all-client common device area 113, which is included in the server apparatus 100, performs reading and writing at any given point in time, and responds to the client apparatus 200 with the result of reading and writing. Hence, the response to the client apparatus 200 is quicker than that in the case of reading from and writing to the external device memory 301.

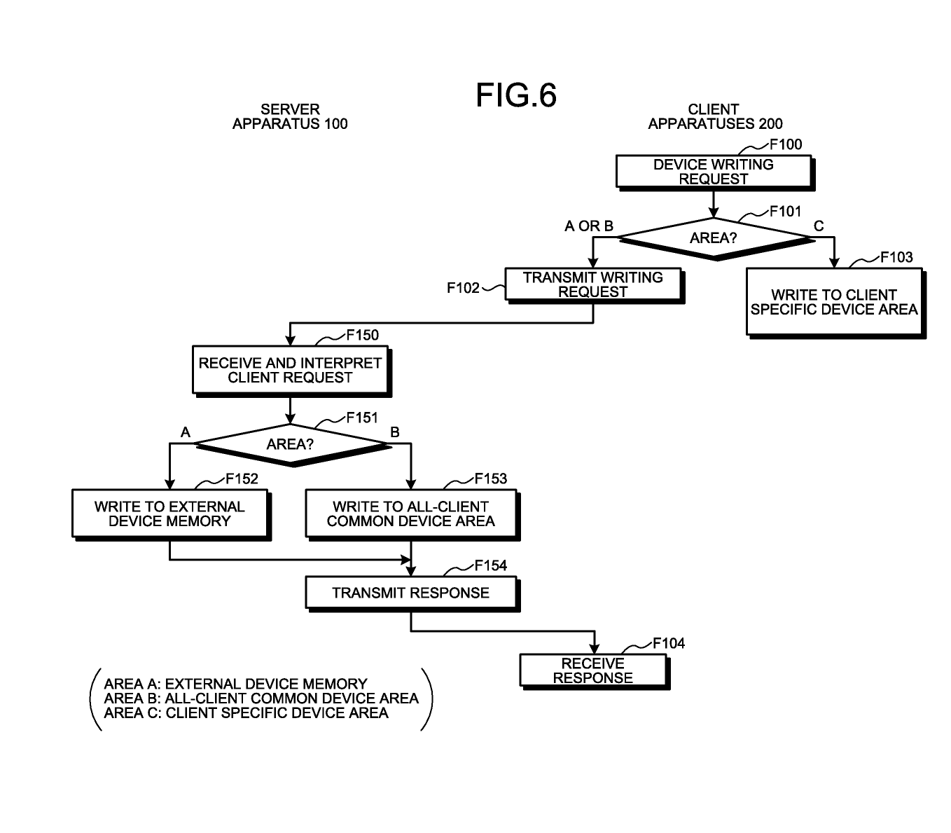

FIG. 6 is a flowchart illustrating processing performed when the client apparatus 200 generates a writing request to a device memory. The flowchart illustrated in FIG. 6 illustrates device writing, out of the device memory reading/writing processing described above.

The client apparatuses 200 issues a device writing request (F100). Then, it is determined which one of areas A to C includes a device memory of the writing target (F101). The area A is the external device memory, the area B is the all-client common device area, and the area C is the client specific device area. If the device of the writing target is the area A or the area B, the writing request is transmitted to the server apparatus 100 (F102). If the device of the writing target is the area C, the client apparatus 200 performs appropriate exclusive control and then performs writing processing on the client specific device area (F103).

Upon receipt of the device writing request from the client apparatus 200, the server apparatus 100 interprets the request (F150) and determines whether the device memory of the writing target is the area A or the area B (F151). If the device memory of the writing target is the area A, which is the external device memory, the writing processing is performed on the external device memory (F152). If the device memory of the writing target is the area B, which is the all-client common device area, the server apparatus 100 performs appropriate exclusive control and then performs the writing processing on the all-client common device area (F153). If the writing processing is performed on the external device memory, or if the writing processing is performed on the all-client common device area, a response to the request is transmitted to the client apparatus 200 after the completion of the writing processing (F154). When the client apparatus 200 receives the response from the server apparatus 100 (F104), a series of processing steps is completed.

Here, processing involving an operation of an object at the client apparatus 200 or device writing by a background function will be described. In general, a display operation terminal apparatus controls an apparatus of the control target by changing a value of a device memory. Here, apparatuses of the control target include the server apparatus 100, the client apparatuses 200, and the external connection apparatus 300. For example, in the case where the operation of production equipment is managed using the external connection apparatus 300, a part of the external device memory 301 in the external connection apparatus 300 is allocated to a parameter or a trigger condition for the apparatus control, and a value of the external device memory 301 is rewritten from the display operation terminal apparatus to allow a control program of the external connection apparatus 300 to perform processing in accordance with the value and thereby enable the operation of the production equipment.

Here, if the external device memory 301 is allowed to be rewritten by multiple display operation terminal apparatuses simultaneously, an operator's operation may be reflected in another display operation terminal apparatus against the will of the operator, causing the other display operation terminal apparatus to perform an unauthorized action. To prevent such an inappropriate operation, it is advisable to provide a scheme to restrict device writing authority according to a result of an operator authentication that authenticates an operator who is to operate the server apparatus 100 or the client apparatus 200 (operator-authentication-coupled operation right control) and a scheme to enable only one of multiple display operation terminal apparatuses to operate to write to a device memory (operation right exclusive control) according to individual purposes.

The operator-authentication-coupled operation right control will be described first. In the case where an operator authentication function of identifying an operator of the server apparatus 100 or the client apparatus 200 by, for example, the combination of a user name and a password is included, the authentication processing is performed by the operator authentication processing unit 135 of the server apparatus 100 for both of the server apparatus 100 and the client apparatus 200. The operator management information 125, which specifies authority of operations involving device writing, is preregistered in the server apparatus 100 for each operator to be authenticated. More specifically, for the operation authority, “prohibition of writing to all the devices”, “prohibition of writing to the external device memory”, and “prohibition of writing to the external device memory and the all-client common device area” can be specified.

A known type of operator authentication is a scheme to provide a “security level” in which an operator is permitted to display and operate an object when the operator has authority of a higher value than a value preset for the object or a scheme to provide a “security group” in which an operator is permitted to operate an object when a group of the operator agrees with a group defined for the object. The control of the authority concerning device writing may be coupled to a security level or a security group, or it may be independent of a security level or a security group.

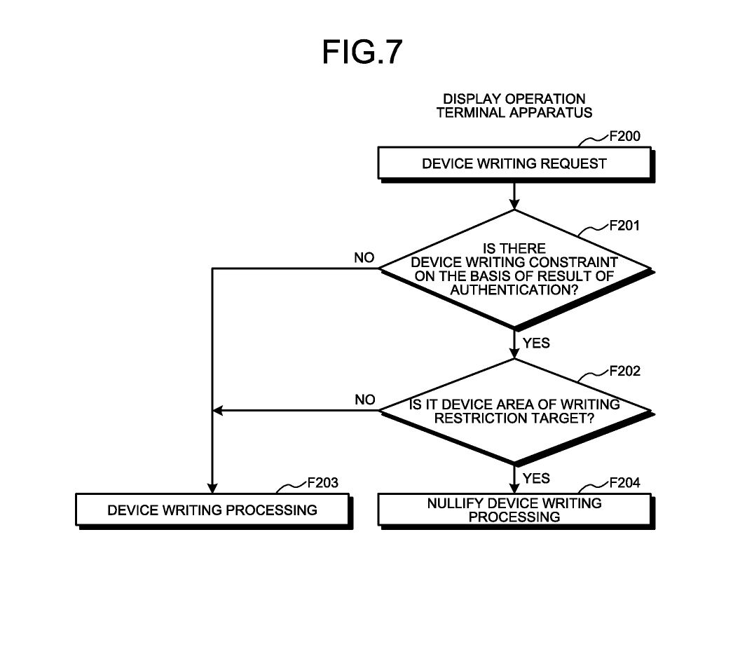

FIG. 7 is a flowchart illustrating device writing processing performed from a display operation terminal apparatus according to a result of operator authentication. It is assumed that an operator of the display operation terminal apparatus has undergone the operator authentication. When the operator operates, for example, an object, a device writing request is generated (F200). Upon generation of the device writing request, the display operation terminal apparatus determines whether or not a device writing constraint is imposed on the operator from a result of the authentication (F201). If there is no device writing constraint, that is, if, in F201, the flowchart takes the path of No, the device writing processing is performed (F203). If there is a device writing constraint, that is, if, in F201, the flowchart takes the path of Yes, it is determined whether or not an area of a device to be written is an area restricted as per authority, that is, whether or not the area is a device area of the writing restriction target (F202). If it is not a device area of the writing restriction target, that is, if, in F202, the flowchart takes the path of No, the device writing processing is performed (F203). If it is a device area of the writing restriction target, that is, if, in F202, the flowchart takes the path of Yes, the device writing processing is nullified (F204).

Specifically, in the case where, for example, “prohibition of writing to the external device memory and the all-client common device area” is specified for the authority of the operator, the device writing processing is performed if the device of the writing target is the “client specific device area,” and the device writing processing is nullified if the device of the writing target is the “external device memory” or the “all-client common device area”.

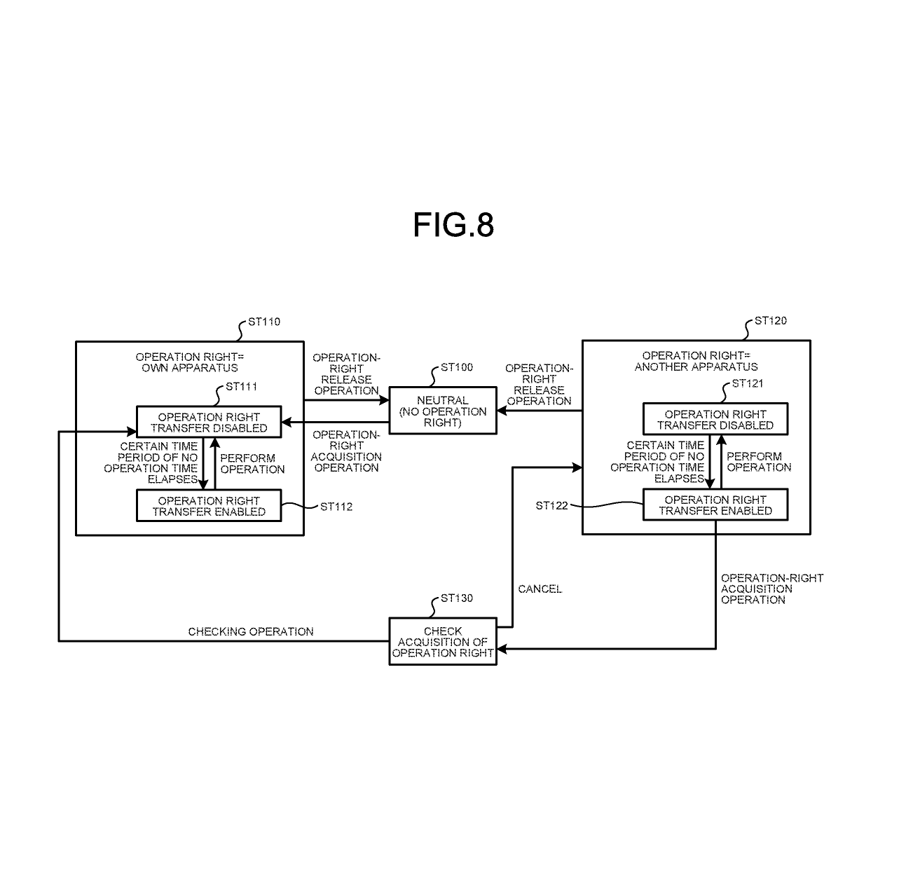

FIG. 8 is a state transition diagram illustrating the state of the operation right, for describing the exclusive control of the operation right. Here, it is assumed that, when the server apparatus 100 is connected to the client apparatuses 200 simultaneously, only one of the display operation terminal apparatuses has the operation right. In FIG. 8, the state of the operation right of each of the display operation terminal apparatuses is “operation right=own apparatus” in which the own apparatus has the operation right (ST110), “operation right=another apparatus” in which the display operation terminal apparatus other than the own apparatus has the operation right (ST120), or “neutral” in which none of the display operation terminal apparatuses has the operation right (ST100). In the case of “neutral” (ST100), the states of the operation right of all of the display operation terminal apparatuses are neutral, and in the case of not neutral, any one of the display operation terminal apparatuses has the operation right such that, with the display operation terminal apparatus having the operation right being represented by Tx, the state of the display operation terminal apparatus Tx is “operation right=own apparatus” (ST110) and the states of all of the other display operation terminal apparatuses except Tx are “operation right=another apparatus” (ST120).

Furthermore, when the display operation terminal apparatus has the operation right, distinction is made between “operation right transfer disabled” in which the operation right cannot be acquired from another display operation terminal apparatus (ST111 and ST121) and “operation right transfer enabled” in which the operation right can be acquired from another display operation terminal apparatus (ST112 and ST122). The operation right states of all of the display operation terminal apparatuses are centrally managed by the operation right management unit 137 of the server apparatus 100. When the state of the operation right is “neutral” (ST100), any of the display operation terminal apparatuses can acquire the operation right at any time. The operation right may be acquired at a timing when an object on which an input operation is performed, which is, for example, a touch switch, is operated; alternatively, a switch that performs an operation-right acquisition operation may be provided in advance on a screen of the display operation terminal apparatus, such that the operation right is acquired by operating the switch.

When the operation right state is “operation right=another apparatus” and “operation right transfer disabled” (ST121), the display operation terminal apparatus that does not have the operation right cannot acquire the operation right. Information that indicates that the operation right cannot be acquired may be displayed all the time in a portion of a screen or may be indicated by using, for example, a dialog when the acquisition operation of the operation right is performed by operating an object.

When the operation right state is “operation right=another apparatus” and “operation right transfer enabled” (ST122), the display operation terminal apparatus that does not have the operation right can acquire the operation right by performing the operation-right acquisition operation. To acquire the operation right, a dialog may be provided to check whether or not there is really a wish to acquire the operation right (ST130), such that the operation right is acquired when the checking is completed and the operation right is not acquired when the operation is cancelled. The operation right acquisition checking (ST130) may be omitted.

The display operation terminal apparatus that has newly acquired the operation right assumes the state of “operation right transfer disabled” (ST111) for a time. If, while in the state of operation right transfer disabled (ST111 and ST121), a no-operation state (in which no object is operated) continues for a certain time period, the state automatically transitions to the state of operation right transfer enabled (ST112 and ST122). By setting the state of operation right transfer disabled and the state of operation right transfer enabled as illustrated in FIG. 8, the display operation terminal apparatus is prevented from failing to complete successive operations, such as inputting values using a ten-key pad on a screen in, for example, an object in which numerical values are input, due to another display operation terminal apparatus acquiring the operation right while the display operation terminal apparatus performing the series of the operations.

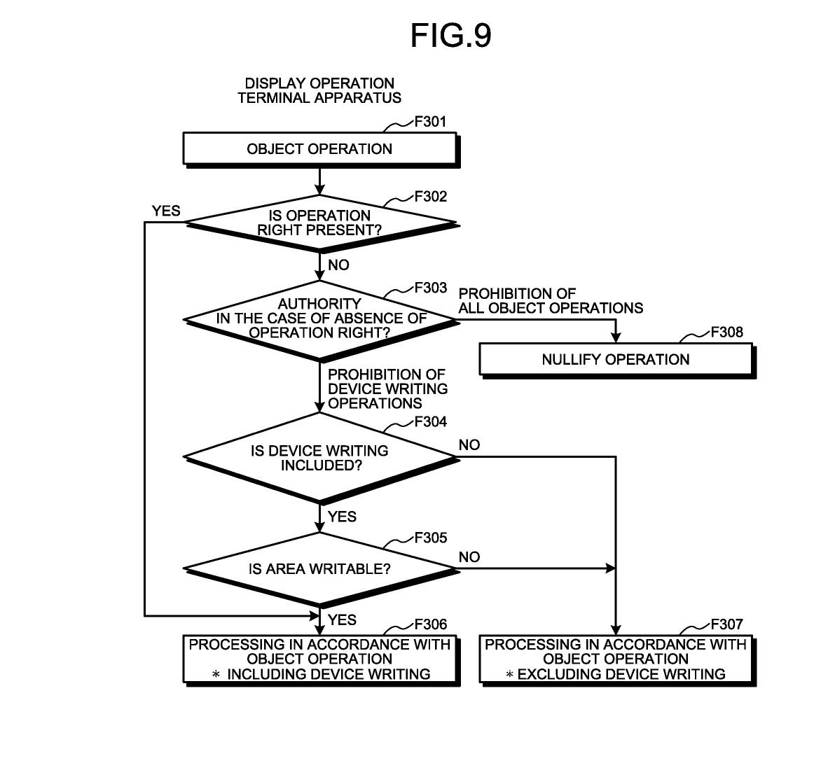

FIG. 9 is a flowchart illustrating writing processing in accordance with the operation right. Here, the restriction range of the authority is determined in advance for the entire system in the case of the absence of the operation right described above; i.e., whether it is set to “prohibition of all object operations” or “prohibition of device writing operations”. Furthermore, in the case of “prohibition of device writing operations”, the range of restriction is determined in advance; i.e., whether it is set to “prohibition of all device writing”, “prohibition of writing to the external device memory”, or “prohibition of writing to the external device memory and the all-client common device area”.

When an object operation is performed (F301), it is determined whether or not the operation right is present (F302). The object operation is, for example, an operation on a touch switch. If the object operation is performed by the display operation terminal apparatus that has the operation right, that is, if, in F302, the flowchart takes the path of Yes, processing in accordance with the object operation is performed (F306). If the object operation is performed by the display operation terminal apparatus that does not have the operation right, that is, if, in F302, the flowchart takes the path of No, the authority in the case of the absence of the operation right is checked to determine which is specified for the authority, “prohibition of all object operations” or “prohibition of device writing operations” (F303). If “prohibition of all object operations” is specified for the authority, the object operation is not accepted and the operation is nullified (F308). If “prohibition of device writing operations” is specified for the authority, it is determined whether or not the processing of the object includes device writing (F304). If device writing is not involved, that is, if, in F304, the flowchart takes the path of No, processing in accordance with the object operation is performed (F307). If device writing is involved, that is, if, in F304, the flowchart takes the path of Yes, it is determined whether or not the authority to write to the target device is present, that is, whether or not the target area is writable (F305). For example, if “prohibition of writing to the external device memory” is specified for the authority, the target area is “writable” for an operation to write to the device of the all-client common device area or the client specific device area, and the target area is “unwritable” for an operation to write to the external device memory. If the area is writable, that is, if, in F305, the flowchart takes the path of Yes, processing including device writing is performed in accordance with the object operation (F306). If the area is unwritable, that is, if, in F305, the flowchart takes the path of No, processing is performed in accordance with the object operation except for the device writing (F307).

The management of the operation right described above can prevent a display operation system including the server apparatus 100 and one or more of the client apparatuses 200 from operating a control target simultaneously and causing an unauthorized action and allow each of the display operation terminal apparatuses to perform an operation that does not affect the control target.

As described above, the present embodiment can provide a display operation system that prevents an unauthorized operation and enables consolidated control to be performed over the entire system and independent control to be performed over each of the display operation terminal apparatuses individually.

The present embodiment will now be described from a different perspective. A display operation apparatus, such as a programmable display, is required in some cases to not only simply display a value of a device memory within an external connection apparatus or a display and be operated but also perform control to change the behavior in accordance with the value of the device memory. For example, with a screen to be displayed rendered controllable as per a value of a device memory, a display operation terminal apparatus, upon detection of an abnormality of the apparatus, allows a certain device memory to issue a notification of the detection of the abnormality and switches a screen automatically to one that lists the description of the abnormality on the basis of the result, or, alternatively, expresses the authority of an operator of the display operation terminal with a value of a device memory and controls whether to or not to display an object or whether to enable or disable an operation in accordance with the value of the device memory.

Furthermore, when a value of a predetermined device memory of a display operation terminal is changed, a change in brightness of the backlight and sounding of the buzzer can be controlled. Such device memories for control or notification include those that should be implemented independently by each of a server apparatus and a client apparatus and those that should be used for control or notification by the server apparatus and the client apparatus in common, and their combinations differ depending on the designer of the system including the display operation terminal apparatus. Here, a device memory for issuing a notification of an action state is referred to as a notification device and a device memory for performing control is referred to as a control device. Such notification devices or control devices can be roughly divided into a system notification device or a system control device, which is specified in advance fixedly by the display operation apparatus, and a user notification device or a user control device, which can be freely specified by a designer who designs the display operation terminal apparatus. Note that the designer here refers to a person who designs, for the display operation apparatus, drawing data that defines a screen or a function of the display operation apparatus by using drawing software, not a designer of a supplier that undertakes the development of firmware in a built-in apparatus for achieving the functions of the display operation apparatus itself or application software for the built-in apparatus.

With a focus on a notification device and a control device, a conventional technique enables a screen of a display operation terminal apparatus that is a server apparatus operating on the basis of drawing data like a programmable display to be viewed and operated from a portable terminal that is a client apparatus, like a personal computer or a tablet PC, located at a different place in production facilities of a plant or in an office outside the production facilities, but has not been able to achieve a scheme to enable the server apparatus and the client apparatus to share the content of the control device or the notification device with each other as necessary and to handle the content of the control device or the notification device independently of each other.

For example, in a conventional method, client apparatuses are only allowed to display a screen generated by a server apparatus; thus, a notification device or a control device unique to each of the client apparatuses cannot be provided. To achieve a function equivalent to a notification device or a control device unique to each of the client apparatuses, a method may be envisaged in which, for example, a certain range of a space of a device memory is assigned as an area for notification devices or control devices for the server apparatus and all of the client apparatuses that can be possibly connected, the server apparatus and the client apparatuses are identified with IP addresses and the like, and addresses in the device memory, which stores information for the server apparatus and each of the client apparatuses, are calculated according to a predetermined rule.

For example, there is a publicly known method in which, with the size of a notification device or a control device for a server apparatus or a client apparatus being Sz and the first address being D0, the first address for information for the Nth apparatus is calculated with D0+(N−1)×Sz, and the control device or the notification device is handled with this address as an offset. In this case, however, an increase in number of the client apparatuses increases the necessary space of the device memory, and furthermore, the offset calculation of an address occurs every time and the complexity of processing increases.

Use of an internal device memory, which is a device memory that allows a server apparatus and a client apparatus to share drawing data with each other and yet operate independently of each other and is provided for each of the display operation apparatuses, enables the state notification or control of the server apparatus or the client apparatus to be performed independently in a method in which the internal device memory is provided independently in each of the server apparatus and the client apparatus. However, a need to control the server apparatus and the client apparatus in common or to allow the server apparatus and the client apparatus to share information with each other requires a control device or a notification device for that purpose to be located in a device memory of an external connection apparatus, such as a PLC, but retention of information for a display operation terminal apparatus in the external connection apparatus is not preferable in some cases depending on the system.

In other words, for a display operation system including a server apparatus and one or more client apparatuses, a scheme that enables a designer to freely set an independent control device or an independent notification device for each of the server apparatus or the one or more client apparatuses and a common control device or a common notification device for the server apparatus or the one or more client apparatuses and that prevents use of an address space of a device memory in a large amount when the number of client apparatuses increases has not been achieved conventionally.

Moreover, in the case where a server apparatus and a plurality of client apparatuses are used simultaneously, permitting the display operation terminal apparatuses to perform an operation to change a device memory of an external connection apparatus simultaneously allows an operator of another display operation terminal apparatus to perform an operation that an operator of each of the display operation terminal apparatuses cannot know, which results in a risk of an unauthorized operation performed on a system of the control target.

As a solution to such problems, setting, for example, an “operation right” such that an operation from any one of the display operation terminal apparatuses only is accepted is envisaged. This, however, has a problem in that the display operation terminal apparatuses that do not have the operation right cannot perform even an operation involving no change to the device memory in each of the display operation terminal apparatuses.

Setting a “consistent display mode” and an “inconsistent display mode” in a plurality of display operation terminal apparatuses and switching between them can solve the problem associated with the switching of screens but not problems other that the switching of screens, which are, for example, the control of authority to display and operate an object.

In the case where, in a display operation system including a server apparatus and a client apparatus, when the client apparatus provides a display operation screen that has the content of display and a function equivalent to those of the server apparatus, an object of the present embodiment is to enable a control device and a notification device of each of the server apparatus and the client apparatus to be common to each other and independent of each other and to have available a space of a device memory for that purpose within the display operation system without the need for a device memory of an external connection apparatus. Additionally, another object is to enable only one of the display operation terminal apparatuses, i.e., the server apparatus or the client apparatus, to perform an operation involving device writing that affects an operation of a control system including an external connection apparatus and to enable the other display operation terminal apparatus to perform an operation that does not affect the operation of the control system.

An aspect of the present invention provides a display operation system in which a server apparatus and a client apparatus are connected through a connection path, the server apparatus operates according to server-use drawing data that defines a function of the server apparatus, the client apparatus operates by acquiring, from the server apparatus through the connection path, client-use drawing data that defines a function of the client apparatus in common and by interpreting the client-use drawing data, the server apparatus and the client apparatus each include an internal device memory to allow a value to be read from and written to the internal device memory, and the internal device memory includes a client specific device area that stores information necessary for independent control of the server apparatus or the client apparatus and an all-client common device area that stores information necessary for control common to the server apparatus and the client apparatus.

Alternatively, another aspect of the present invention provides a display operation system in which a server apparatus and a client apparatus are connected through a first connection path, the server apparatus is connected to an external connection apparatus through a second connection path, the external connection apparatus includes an external device memory to allow the server apparatus or the client apparatus to read from and write to the external device memory through the second connection path, the server apparatus operates according to server-use drawing data that defines a function of the server apparatus, the client apparatus operates by acquiring, from the server apparatus through the first connection path, client-use drawing data that defines a function of the client apparatus in common and by interpreting the client-use drawing data, the server apparatus and the client apparatus each include an internal device memory to allow a value to be read from and written to the internal device memory, the internal device memory includes a client specific device area that stores information necessary for independent control of the server apparatus or the client apparatus and an all-client common device area that stores information necessary for control common to the server apparatus and the client apparatus, the client specific device area and the all-client common device area are virtually located in a series of address spaces in the internal device memory on the basis of locations defined in the server-use drawing data and the client-use drawing data, and the client apparatus is allowed to read from and write to the client specific device area and the all-client common device area through the first connection path.

Alternatively, another aspect of the present invention provides a display operation system in which one server apparatus and a plurality of client apparatuses are connected through a first connection path, the server apparatus is connected to an external connection apparatus through a second connection path, the external connection apparatus includes an external device memory to allow the server apparatus or the client apparatuses to read from and write to the external device memory through the second connection path, the server apparatus operates according to server-use drawing data that defines a function of the server apparatus, the client apparatuses operate by acquiring, from the server apparatus through the first connection path, client-use package data including client-use drawing data that defines functions of all of the client apparatuses in common and by interpreting the client-use package data, the server apparatus and all of the client apparatuses each include an internal device memory to allow a value to be read from and written to the internal device memory, the internal device memory includes a client specific device area that stores information necessary for independent control of the server apparatus or each of the client apparatuses and an all-client common device area that stores information necessary for control common to the server apparatus and all of the client apparatuses, the client specific device area and the all-client common device area are virtually located in a series of address spaces in the internal device memory on the basis of locations defined in the server-use drawing data and the client-use drawing data, and the client apparatuses are allowed to read from and write to the client specific device area and the all-client common device area through the first connection path. The client-use package data may include a client-use application that is a part of software that enables the client apparatuses to operate.

In the configurations described above, a control device or a notification device of each of display operation terminal apparatuses included in a display operation system is placed in a corresponding internal device memory, information shared by all of the display operation terminal apparatuses is placed in a corresponding all-client common device area, and information that should be handled independently by each of the display operation terminal apparatuses is placed in a corresponding client specific device area; this placement allows drawing data of each of the display operation terminal apparatuses to be common, achieves control or notification common to all of the display operation terminal apparatuses without the use of a device memory of an external connection apparatus, and enables independent control or notification of each of the display operation terminal apparatuses. This enables, for example, each of the display operation terminal apparatuses to switch screens independently and all of the display operation terminal apparatuses to retain information that identifies the display operation terminal apparatuses that are currently performing an operation in common. In particular, to take a programmable display as a specific example, an internal device memory that stores such a control device or a notification device is made available in terms of locations and has a limited size, but with the configurations described above, the all-client common device area and the client specific device area can be allocated in the limited space freely in accordance with the uses. The degree of freedom of such a type is an important feature for an apparatus that requires a designer to freely design its functions, such as a programmable display, that is, an apparatus for which its supplier cannot specify memory locations in a semi-fixed manner unlike a general built-in apparatus. As long as the allocation of the all-client common device area and the client specific device area is common to all of the display operation terminal apparatuses, the drawing data does not necessarily have to be common. When a client apparatus includes in advance a scheme for operating by interpreting the client-use drawing data, the server apparatus may provide only “client-use drawing data”. The server apparatus may provide also a client-use application, and when the server apparatus does provide also a client-use application, there is no need for a client apparatus to preinstall a client-use application, and the server apparatus can provide a combination of the client-use drawing data included in the server apparatus and a client-use application suitable for the client-use drawing data to the client apparatus.

Furthermore, in the configurations described above, the server apparatus is preferably a programmable display that is capable of providing a display operation function according to the server-use drawing data and reading from and writing to the external device memory of the external connection apparatus. Such a configuration can reduce the burden on the external connection apparatus, especially when a plurality of client apparatuses is present, because the server apparatus performs the communication on behalf of each of the client apparatuses, instead of each of the client apparatuses communicating with the external connection apparatus independently.

Additionally, in the configurations described above, an operator is allowed to specify internal device address allocation information that is an address range to be allocated to each of the all-client common device area and the client specific device area in the internal device memory, and the internal device address allocation information is preferably defined as an area common to the server-use drawing data and the client-use drawing data. With such a configuration, the address range to be allocated to each of the all-client common device area and the client specific device area is set in the server-use and client-use drawing data, and thus, allocation of the device areas corresponding to a system to be configured by a designer is enabled.

In the configurations described above, the server apparatus includes an operator authentication processing unit to authenticate an operator of the server apparatus and the client apparatus, the operator authentication processing unit includes per-operator operation right information for managing operating authority to be granted to the operator to be authenticated, when authentication is successful, authority to operate the server apparatus or the client apparatus specified by the operator is defined in the per-operator operation right information and a description of an operation performable on each of an object and a background function defined in the drawing data of the server apparatus or the client apparatus is allowed to be defined for each operation right, and as the description of an operation, whether a device value is allowed to be written to the internal device memory and the external device memory is preferably controlled. With such a configuration, whether a device value is allowed to be written to the internal device memory and the device memory of the external connection apparatus can be controlled according to a result of the authentication on the operator of the server apparatus or the client apparatus, while various objects can be operated regardless of the result of the authentication on the operator. When, in particular, the result of the authentication does not satisfy a certain requirement, it is possible to restrict only an operation that affects the entire system while enabling an independent operation to be performed on each of the display operation terminal apparatuses by prohibiting only device writing to the all-client common device area in the internal device memory and the device memory of the external connection apparatus and permitting device writing to the client specific device area; hence, it is possible to permit each of the display operation terminal apparatuses to switch and view different screens or to perform an operation to make a change to a parameter closed within each of the display operation terminal apparatuses while prohibiting an operation that affects the entire system. Furthermore, since the authentication of an operator of the client apparatus is performed by the server apparatus, disguising as, for example, an application of the client apparatus and impersonating an operator having all the operating authority, that is, an operator having the administrator authority, to perform an unauthorized operation on the system can be prevented. This effect can be operated more strictly particularly when the server apparatus is a programmable display capable of providing the display operation function according to the server-use drawing data and reading from and writing to the external device memory of the external connection apparatus and when the server apparatus centrally manages the access to the device memory of the external connection apparatus and the all-client common device area. This is because the server apparatus, when exercising centralized control on a communication request from the client apparatus, can determine the authority of the client and whether the communication request can be performed.

In the configurations described above, when the client apparatuses are connected to the server apparatus simultaneously, a device-writing operation right to write to the internal device memory and the external device memory is set in the client apparatuses and the server apparatus, a state of the device-writing operation right is any of a state in which another apparatus has an operation right, a state in which an own apparatus has the operation right, and a state in which none of the own apparatus and the other apparatus has the operation right, preferably, any of the client apparatuses or the server apparatus that has the operation right is enabled to perform an operation involving the device writing, and any of the client apparatuses or the server apparatus that does not have the operation right is prohibited from all device writing. Alternatively, when the client apparatuses are connected to the server apparatus simultaneously, a state of a device-writing operation right to write to the internal device memory and the external device memory is set in the client apparatuses and the server apparatus, the state of the device-writing operation right is any of a state in which another apparatus has an operation right, a state in which an own apparatus has the operation right, and a state in which none of the own apparatus and the other apparatus has the operation right, preferably, any of the client apparatuses or the server apparatus that has the operation right is enabled to perform an operation involving the device writing, and any of the client apparatuses or the server apparatus that does not have the operation right is enabled to perform an operation involving the device writing to only the client specific device area of the any of the client apparatuses or the server apparatus. With such a configuration, only one of the display operation terminal apparatuses has an operation right such that the only one of the display operation terminal apparatuses that has the operation right is enabled to perform a device-writing operation while the range of devices to which one of the terminals that does not have the operation right can write is restricted. Moreover, with the three states of the operation right present as viewed from each of the display operation terminal apparatuses: i.e., a state in which another apparatus has the operation right, a state in which an own apparatus has the operation right, and a state in which none of the apparatuses has the operation right, the operation right is managed such that an operator is caused to operate to acquire the operation right explicitly when the other apparatus has the operation right, and when the own apparatus has the operation right or when none of the apparatuses has the operation right, the display operation terminal apparatus that performs an operation has the operation right and is enabled to perform operations. In a system including a plurality of display operation terminal apparatuses, this restricts device writing operations performed simultaneously by the display operation terminal apparatuses, thereby preventing a risk of an unintended, unauthorized operation performed on the system.

### REFERENCE SIGNS LIST

100 server apparatus, 101 display input apparatus, 110 volatile memory, 111 internal device memory, 112 client specific device area, 113 all-client common device area, 114 work memory, 120 nonvolatile memory, 121 server-use drawing data, 122 client-use package data, 122a client-use application, 122b client-use drawing data, 124 resource data, 125 operator management information, 130 server apparatus control unit, 131 server apparatus operation input processing unit, 132 server apparatus display processing unit, 133 background function processing unit, 134 server-use drawing data interpretation processing unit, 135 operator authentication processing unit, 136 client-use data management unit, 137 operation right management unit, 138 client-use package data provision processing unit, 139 client apparatus request processing unit, 140 communication-with-client processing unit, 141 device memory communication processing unit, 151 first communication interface, 152 second communication interface, 200 client apparatus, 201 display input apparatus, 210 volatile memory, 211 internal device memory, 212 client specific device area, 213 all-client common device area, 214 work memory, 220 nonvolatile memory, 222 client-use application, 223 client-use drawing data, 225 client specific information, 230 client apparatus control unit, 231 client apparatus operation input processing unit, 232 client apparatus display processing unit, 233 background function processing unit, 234 client-use drawing data interpretation processing unit, 235 request-to-server generation processing unit, 240 communication-with-server processing unit, 251 first communication interface, 300 external connection apparatus, 301 external device memory, 401 first connection path, 402 second connection path, 500 system control device, 510 user-use internal device, 511 word device, 512 bit device.

1. A display operation system in which a server apparatus is connected to a client apparatus and an operation is performed with a monitor screen of the client apparatus, wherein
data for use in individual and independent control in the server apparatus is stored and loaded in the server apparatus,
data for use in individual and independent control in the client apparatus is stored and loaded in the client apparatus, and
data to be shared and for use in consolidated control over the entire display operation system is shared by the server apparatus and the client apparatus.

2. A display operation system in which a server apparatus and a client apparatus are connected through a connection path and an operation is performed with a monitor screen of the client apparatus, wherein
the server apparatus operates according to server-use drawing data that defines a function of the server apparatus,
the client apparatus operates by acquiring, from the server apparatus through the connection path, client-use drawing data that defines a function of the client apparatus in common and by interpreting the client-use drawing data,
data for use in individual and independent control in the server apparatus is stored and loaded in a client specific device area in an internal device memory of the server apparatus,
data for use in individual and independent control in the client apparatus is stored and loaded in a client specific device area in an internal device memory of the client apparatus, and
data to be shared and for use in consolidated control over the entire display operation system is shared by all-client common device areas of the server apparatus and the client apparatus.

3. A display operation system in which a server apparatus and a client apparatus are connected through a first connection path, the server apparatus is connected to an external connection apparatus through a second connection path, and an operation is performed with a monitor screen of the client apparatus, wherein
the external connection apparatus includes an external device memory to allow the server apparatus or the client apparatus to read from and write to the external device memory through the second connection path,
the server apparatus operates according to server-use drawing data that defines a function of the server apparatus,
the client apparatus operates by acquiring, from the server apparatus through the first connection path, client-use drawing data that defines a function of the client apparatus in common and by interpreting the client-use drawing data,
data for use in individual and independent control in the server apparatus is stored and loaded in a client specific device area in an internal device memory of the server apparatus,
data for use in individual and independent control in the client apparatus is stored and loaded in a client specific device area in an internal device memory of the client apparatus,
data to be shared and for use in consolidated control over the entire display operation system is shared by all-client common device areas of the server apparatus and the client apparatus,
the client specific device area and the all-client common device areas are virtually located in a series of address spaces in the internal device memory on a basis of locations defined in the server-use drawing data and the client-use drawing data, and
the client apparatus is allowed to read from and write to the client specific device area and the all-client common device areas through the first connection path.

4. A display operation system in which one server apparatus and a plurality of client apparatuses are connected through a first connection path, the server apparatus is connected to an external connection apparatus through a second connection path, and an operation is performed with a monitor screen of the client apparatuses, wherein
the external connection apparatus includes an external device memory to allow the server apparatus or the client apparatuses to read from and write to the external device memory through the second connection path,
the server apparatus operates according to server-use drawing data that defines a function of the server apparatus,
the client apparatuses operate by acquiring, from the server apparatus through the first connection path, client-use package data including client-use drawing data that defines functions of all of the client apparatuses in common and by interpreting the client-use package data,
data for use in individual and independent control in the server apparatus is stored and loaded in a client specific device area in an internal device memory of the server apparatus,
data for use in individual and independent control in the client apparatuses is stored and loaded in a client specific device area in an internal device memory of the client apparatuses,
data to be shared and for use in consolidated control over the entire display operation system is shared by all-client common device areas of the server apparatus and the client apparatuses,
the client specific device area and the all-client common device areas are virtually located in a series of address spaces in the internal device memory on a basis of locations defined in the server-use drawing data and the client-use drawing data, and
the client apparatuses are allowed to read from and write to the client specific device area and the all-client common device areas through the first connection path.

5. The display operation system according to claim 4, wherein the client-use package data includes a client-use application that is a part of software that enables the client apparatuses to operate.

6. The display operation system according to claim 3, wherein the server apparatus is a programmable display capable of providing a display operation function according to the server-use drawing data and reading from and writing to the external device memory.

7. The display operation system according to claim 2, wherein
a designer of the server-use drawing data and the client-use drawing data is allowed to specify internal device address allocation information that is an address range to be allocated to each of the all-client common device areas and the client specific device area in the internal device memory, and
the internal device address allocation information is defined as an area common to the server-use drawing data and the client-use drawing data.

8. The display operation system according to claim 3, wherein
the server apparatus includes an operator authentication processing unit to authenticate an operator of the server apparatus and the client apparatus,
the operator authentication processing unit includes per-operator operation right information for managing operating authority to be granted to the operator to be authenticated,
when authentication is successful, authority to operate the server apparatus or the client apparatus specified by the operator is defined in the per-operator operation right information and a description of an operation performable on each of an object and a background function defined in the drawing data of the server apparatus or the client apparatus is allowed to be defined for each operation right, and
as the description of an operation, whether a device value is allowed to be written to the internal device memory and the external device memory is controlled.

9. The display operation system according to claim 4, wherein,
when the client apparatuses are connected to the server apparatus simultaneously, a device-writing operation right to write to the internal device memory and the external device memory is set in the client apparatuses and the server apparatus,
a state of the device-writing operation right is any of a state in which another apparatus has an operation right, a state in which an own apparatus has the operation right, and a state in which none of the own apparatus and the another apparatus has the operation right,
any of the client apparatuses or the server apparatus that has the operation right is enabled to perform an operation involving device writing, and
any of the client apparatuses or the server apparatus that does not have the operation right is prohibited from all device writing.

10. The display operation system according to claim 4, wherein,
when the client apparatuses are connected to the server apparatus simultaneously, a device-writing operation right to write to the internal device memory and the external device memory is set in the client apparatuses and the server apparatus,
a state of the device-writing operation right is any of a state in which another apparatus has an operation right, a state in which an own apparatus has the operation right, and a state in which none of the own apparatus and the another apparatus has the operation right,
any of the client apparatuses or the server apparatus that has the operation right is enabled to perform an operation involving device writing, and
any of the client apparatuses or the server apparatus that does not have the operation right is enabled to perform an operation involving the device writing to only the client specific device area of the any of the client apparatuses or the server apparatus.

11. The display operation system according to claim 4, wherein the server apparatus is a programmable display capable of providing a display operation function according to the server-use drawing data and reading from and writing to the external device memory.

12. The display operation system according to claim 3, wherein
a designer of the server-use drawing data and the client-use drawing data is allowed to specify internal device address allocation information that is an address range to be allocated to each of the all-client common device areas and the client specific device area in the internal device memory, and
the internal device address allocation information is defined as an area common to the server-use drawing data and the client-use drawing data.

13. The display operation system according to claim 4, wherein
a designer of the server-use drawing data and the client-use drawing data is allowed to specify internal device address allocation information that is an address range to be allocated to each of the all-client common device areas and the client specific device area in the internal device memory, and
the internal device address allocation information is defined as an area common to the server-use drawing data and the client-use drawing data.

14. The display operation system according to claim 4, wherein
the server apparatus includes an operator authentication processing unit to authenticate an operator of the server apparatus and the client apparatus,
the operator authentication processing unit includes per-operator operation right information for managing operating authority to be granted to the operator to be authenticated,
when authentication is successful, authority to operate the server apparatus or the client apparatus specified by the operator is defined in the per-operator operation right information and a description of an operation performable on each of an object and a background function defined in the drawing data of the server apparatus or the client apparatus is allowed to be defined for each operation right, and
as the description of an operation, whether a device value is allowed to be written to the internal device memory and the external device memory is controlled.
